(19) United States
(12) Patent Application Publication
(10) Pub. No.: US 2009/0237221 A1
(43) Pub. Date: Sep. 24, 2009

(54) Label programmer, system, and method of initializing RF-enabled labels

(75) Inventors: Kevin G. Battles, El Paso, TX (US); Curtis B. Hause, St. Paul, MN (US); G. Phillip Rambosek, Shafer, MN (US); Stephen J. Rothermel, Roseville, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 12/079,047

(22) Filed: Mar. 24, 2008

(51) Int. Cl. H04Q 5/22

(52) U.S. Cl. 340/10.51

(57) ABSTRACT

A label programming system configured to initialize a radiofrequency (RF)-enabled label for attachment to a data storage device includes a platform, an RF read/write assembly disposed on a first side of the platform, and an optical reader assembly in electrical communication with the RF read/write assembly. The optical reader assembly is disposed on a second side of the platform opposite the first side. The optical reader assembly is configured to optically read information from the RF-enabled label and communicate the information to the RF read/write assembly that is configured to write the information to a chip of the RF-enabled label.

### BACKGROUND

Data storage devices are employed in computer, audio, and video fields for storing large volumes of information for subsequent retrieval and use. Data storage devices include data storage tape cartridges, hard disk drives, micro disk drives, business card drives, and removable memory storage devices in general. The data storage devices are useful for storing data and for backing up data systems used by businesses and government entities. For example, businesses routinely back up important information such as human resource data, employment data, compliance audits, and safety/inspection data. Government sources collect and store vast amounts of data related to tax payer identification numbers, income withholding statements, and audit information. Congress has provided additional motivation for many publicly traded companies to ensure the safe retention of data and records related to government required audits and reviews after passage of the Sarbanes-Oxley Act (Pub. L. 107-204, 116 Stat. 745 (2002)).

Collecting and storing data has now become a routine good-business practice. The data is often saved to one or more data storage devices that is/are typically shipped or transferred to an offsite repository for safe/secure storage. The backup data storage devices are periodically retrieved from the offsite repository for review. The transit of data storage devices between various facilities introduces a possible risk of loss or theft of the devices and the data stored that is stored on the devices.

The issue of physical data security and provenance is a growing concern for users of data storage devices. Thus, manufacturers and users both are interested in systems and/or processes for keeping track of in-transit/in-storage data storage devices. Improvements to the tracing of data storage devices used to store data are desired by a wide segment of both the public and private business sectors.

### SUMMARY

One aspect provides a label programming system configured to initialize a radiofrequency (RF)-enabled label for attachment to a data storage device. The label programming system includes a platform, an RF read/write assembly disposed on a first side of the platform, and an optical reader assembly in electrical communication with the RF read/write assembly. The optical reader assembly is disposed on a second side of the platform opposite the first side. The optical reader assembly is configured to optically read information from the RF-enabled label and communicate the information to the RF read/write assembly that is configured to write the information to a chip of the RF-enabled label.

Another aspect provides a label programming system configured to initialize a label for attachment to a data storage device. The system includes a platform, an RF read/write assembly disposed on a first side of the platform, and an optical reader assembly in electrical communication with the RF read/write assembly. The platform includes a first shield and a second shield spaced from the first shield by a gap. The optical reader assembly is disposed on a second side of the platform opposite the first side. The optical reader assembly is configured to optically read information from an RF-enabled label presented in the gap and communicate the information to the RF read/write assembly that is configured to write the information to a chip of the RF-enabled label.

Another aspect provides a method of initializing a label for attachment to a data storage device. The method includes providing an array of radiofrequency (RF)-enabled labels. The method additionally includes optically reading information from one row or one column of the array of RF-enabled labels, and shielding all but the one row or column of the RF-enabled labels that was optically read. The method ultimately includes radiofrequency writing the optically read information to a chip in each RF-enabled label in the row or column of the RF-enabled labels that was not shielded.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a label programming system configured to initialize a radio frequency (RF)-enabled label for attachment to a data storage device according to one embodiment;

FIG. 2 is an exploded view of a label programmer of the label programming system shown in FIG. 1 according to one embodiment;

FIG. 3 is a top view of a housing maintaining RF read/write assemblies according to one embodiment;

FIG. 4 is a top view of a platform of the label programmer shown in FIG. 2 according to one embodiment;

FIG. 5 is a bottom view of the platform shown in FIG. 4;

FIG. 6A is a perspective view of the label programmer shown in FIG. 2 employed to initialize an array of RF-enabled labels according to one embodiment;

FIG. 6B is a perspective view of one of the RF-enabled labels shown in FIG. 6A;

FIG. 7 is a front view of a startup screen of a user interface of the label programming system according to one embodiment;

FIG. 8 is a front view of an initialization screen of the user interface;

FIG. 9 is a front view of a barcode scanning screen of the user interface; and

FIG. 10 is a front view of a verification screen of the user interface.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

Embodiments provide a label programming system that is configured to initialize a radiofrequency (RF)-enabled label for attachment to a data storage device. Embodiments of the system offer a turn-key solution for entities to trace and track the movement of data storage devices within and between physical locations.

Embodiments provide a label programming system configured to scan a barcode of a label that is attachable to a data storage device and convert and write the scanned information onto a chip of an RF-enabled inlay embedded within the label. Embodiments provide a label programming system enabled to verify/read RFID-enabled tags and ensure that the information written to the chip matches the barcode printed on the label prior to attaching the label to the data storage device. In one embodiment, the label programming system includes ultra high frequency (UHF) read/write components suited to UHF initialize RF-enabled labels.

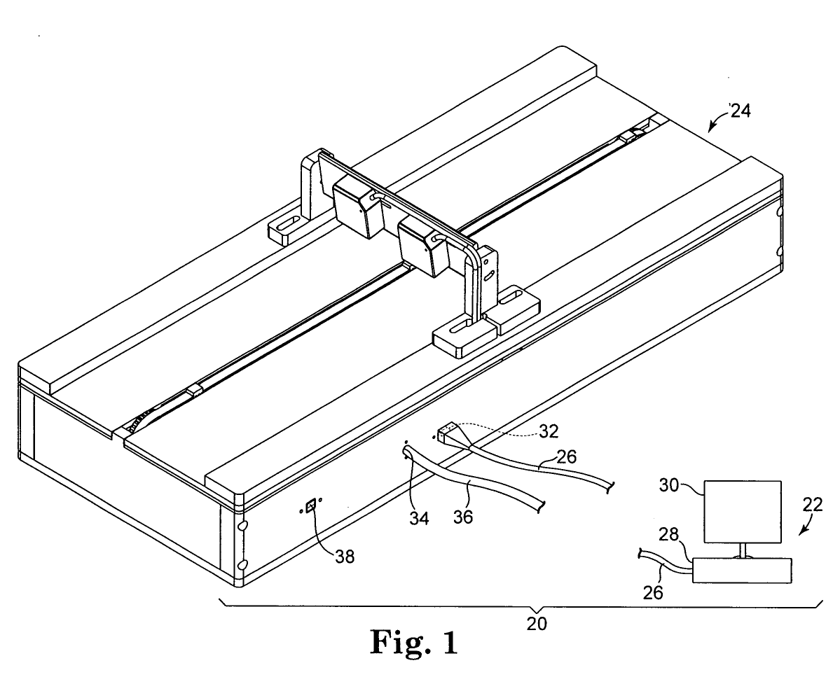

FIG. 1 is a perspective view of a label programming system 20 according to one embodiment. The label programming system 20 (system 20) includes an interface 22 coupled to a label programmer 24 by an electrical cable 26. In one embodiment, the interface 22 includes a controller 28 coupled to the label programmer 24 by the cable 26 and a graphical user interface (GUI) 30 configured to enable a user to interact with the label programmer 24 when initializing labels for attachment to data storage devices. The controller 28 includes computers and like devices configured to operate software that is user-operable via the GUI 30 (e.g., a monitor). In another embodiment, the controller 28 is internal to the programmer 24. In one embodiment, the label programmer 24 includes an output port 32 to which the cable 26 connects, a power port 34 communicating with a power cable 36, and an on/off switch 38.

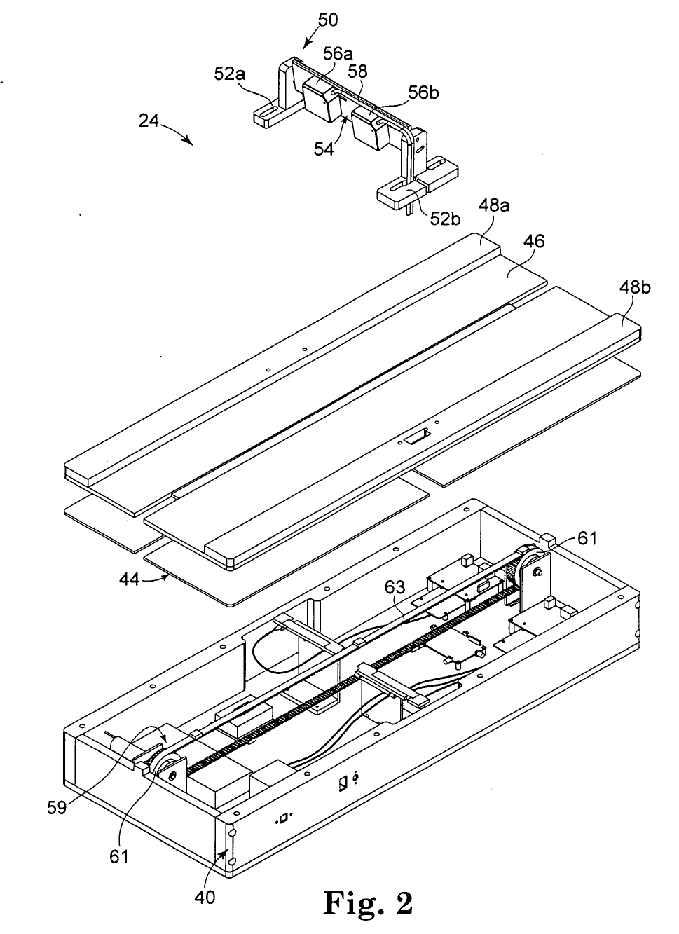

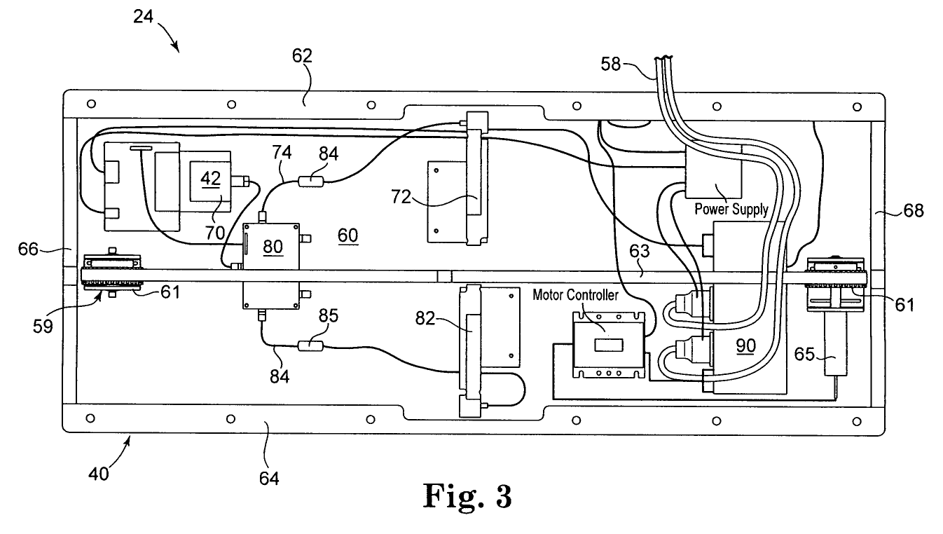

FIG. 2 is an exploded view of the label programmer 24. In one embodiment, the label programmer 24 includes a housing 40 maintaining one or more RF read/write assemblies 42 (See FIG. 3), a platform 44 coupled to housing 40, a work surface 46 or support 46 disposed over the platform 44, guides 48a, 48b disposed along opposing lateral sides of the support 46, and an optical reader assembly 50 coupled to the guides 48a, 48b.

In one embodiment, optical reader assembly 50 includes a pair of bases 52a, 52b each coupled to a respective one of the guides 48a, 48b, a U-arm 54 (e.g., an arch 54) coupled to the bases 52a, 52b, and a pair of optical scanners 56a, 56b secured to the arch 54. The arch 54 is elevated above the work surface 46 and is configured to enable a sheet of RF-enabled labels to traverse beneath the optical scanners 56a, 56b. In one embodiment, the optical scanners 56a, 56b are in electrical communication with the RF read/write assembly 42 via electrical cables 58, and the programmer 24 communicates with the controller 28 to individually initialize each label of the sheet of RF-enabled labels. Suitable optical scanners include one of the MS-series of scanners available from MICROSCAN, Renton, Wash. Other suitable optical scanners are also acceptable.

In one embodiment, an optional belt system 59 is provided to direct a sheet of RF-enable labels across the work surface 46. The belt system includes gears 61 and a belt 63 engaged over the gears 61. The belt is configured to ride over the platform 44 and move a sheet of labels along the work surface 46. Other means for moving a sheet of labels are also acceptable, including manually indexing the sheet or a pinch roller system suited to move the sheet carrying the labels.

FIG. 3 is a top view of the housing 40 and the RF read/write assembly 42 maintained within the housing 40. The view of FIG. 3 shows the label programmer 24 with the platform 44 and the support 46 (FIG. 2) removed such that the RF read/write assembly 42 is visible. In one embodiment, the housing 40 forms a container defined by a bottom 60, opposing lateral sides 62, 64, and opposing ends 66, 68. The RF read/write assembly 42 and the belt system 59 are disposed within the housing 40. The belt system 59 includes a motor 65 adapted to drive the gears 61 and the belt 63.

The RF read/write assembly 42 includes a first reader/writer 70 electrically coupled to an RF multiplexer 80 having cables 74, 84 extending to RF antennas 72, 82, respectively. In one embodiment, the cables 74, 84 include ferrite cores 75, 85, respectively, disposed around the coaxial cables. The ferrite shielded cores 75, 85 of cables 74, 84 are configured to isolate the antennas 72, 82 from electrical disturbances from the reader 70 and other electronics, thus improving the reliability of the label programmer 24. In addition, the ferrite shielded cores 75, 85 of cables 74, 84 also isolate antennas 72, 82 from each other, thus reducing misreads. A signal converter 90 is disposed within the housing 40 and provides a universal serial bus port adapter.

In one embodiment, the RF reader/writer 70 includes SkyeTek SkyeModule M9 ultra high frequency (UHF) RFID reader available from SkyeTek, Westminster, Colo. In one embodiment, the RF antennas 72, 82 include ultra high frequency RF antennas identified as SIRIT part number H1483-351 antennas having an area of about 0.5 inch by 3 inches. Other suitable antennas include “miniature” patch antennas with impedance matching elements, zigzag monopole or dipole antennas, coiled monopole or dipole antennas, a Fractus FR05-S1-R-0-105 antenna, an Antenova 1020B5812-01 antenna, or a Tyco Electronics series 1513165 antenna, and other antennas having an operating frequency near 900 MHz.

Label programmer 24 also includes a power supply, a motor controller for the belt system 59 motor, interface cables, and USB, power jacks, and a belt position sensor suitably wired in a manner that those with skill in the art will understand.

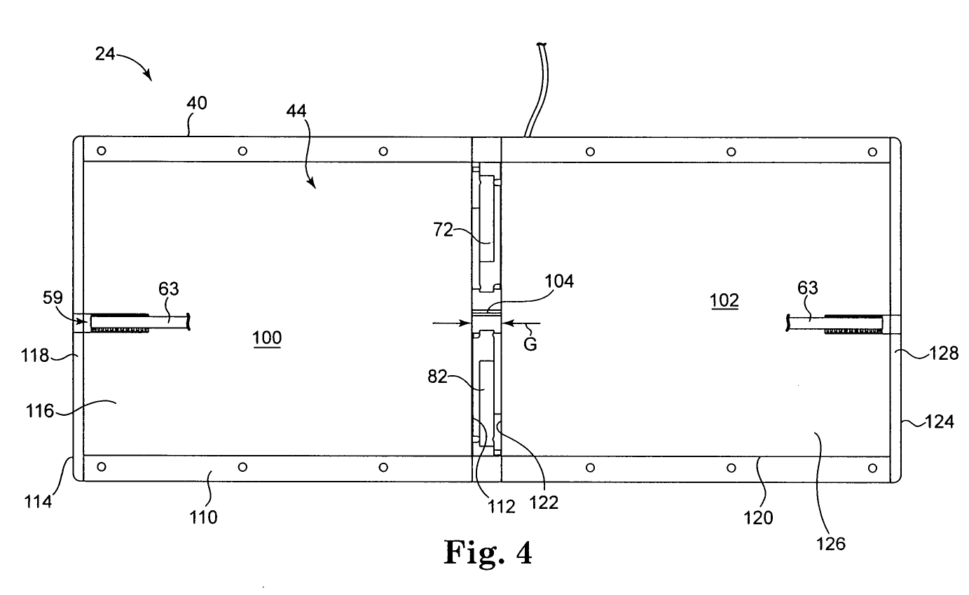

FIG. 4 is a top view of a portion of label programmer 24 including the platform 44 placed on the housing 40 over the belt system 59. In one embodiment, the platform 44 includes a first shield 100 spaced from a second shield 102 by a gap G. The platform 44 is placed atop the housing 40, and the antennas 72, 82 are aligned within the gap G under the shields 100, 102 in line-of-sight of the optical scanners 56a, 56b.

In one embodiment, the first shield 100 includes a panel 110 that defines a leading end 112 and a trailing end 114 and includes a metal foil 116 extending between the leading end 112 and the trailing end 114. In one embodiment, the second shield 102 includes a panel 120 defining a leading end 122 opposite a trailing end 124 and a metal foil 126 extending between leading end 122 and trailing end 124. In one embodiment, the trailing ends 114, 124 each include an optional insulator 118, 128 disposed over the respective metal foils 116, 126 to minimize the possibility of electrical contact between a user and metallic (i.e., conductive) portions the trailing ends 114, 124. Suitable panels 110, 120 include plastic panels about 0.125 inches thick, although other panels of other thicknesses are also acceptable.

The antennas 72, 82 aligned in the gap G are positioned in a line-of-sight of the optical scanners 56a, 56b. In this manner, one or more RF-enabled tags traversing the gap G are aligned with the optical scanners 56a, 56b and the antennas 72, 82, such that the RF reader/writer 70 is enabled to read/write only to those tags that are in line with the optical scanners 56a, 56b. Moving a series of tags over the gap G results in one row of tags being positioned between the antennas 72, 82 and the RF reader/writer 70. In one embodiment, the work surface 46 (FIG. 2) includes a smooth plastic plate having an area of about 9×12 inches that facilitates the unfettered movement of the tags across the gap G. This one row of tags is suited for initialization in which information optically read by scanners 56 off of the tags in the gap G is coupled to the RF reader/writer 70, which electronically writes the information to a chip in each tag.

In one embodiment, the gap G between the first shield 100 and the second shield 102 is adjustably maintained by an optional divider 104 coupled between the shields 100, 102.

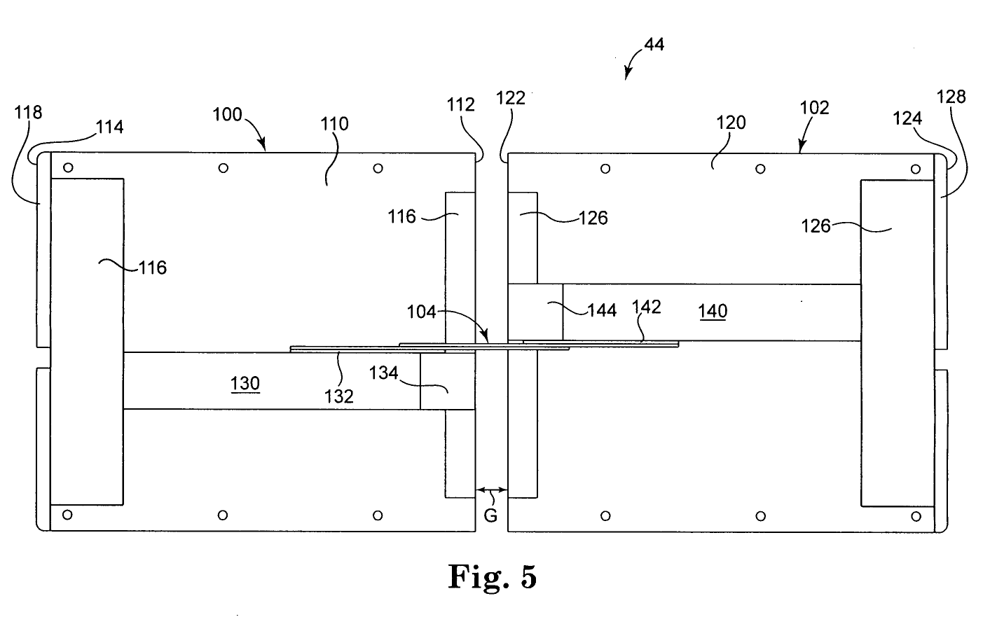

FIG. 5 is a bottom view of the platform 44. In one embodiment, the metal foil 116 extends between the leading end 112 and the trailing end 114 of the panel 110, and the metal foil 126 extends between the leading end 122 and the trailing end 124 of the panel 120. In general, the leading ends 112, 122 are spaced apart by the adjustable gap G dimension.

It is desirable that the platform 44 be configured to prevent RF read/writing to tags that are not within the line-of-sight of the antennas 72, 82 (FIG. 4). In one embodiment, the platform 44 is sized to be at least 1 inch longer than the sheet to which the tags are attached. In another embodiment, the platform 44 is wrapped by the metal foil 116, 126 to prevent undesirable antenna transmission to tags other than the targeted tags. For example, in one embodiment the metal foil 116 wraps around the trailing end 114 and extends up to the leading end 112 in a manner that is configured to enable the shield 100 to prevent the antennas 72, 82 from undesirably writing to or otherwise affecting labels placed on the platform 44 that are not presented in the gap G. In another embodiment, as illustrated, the metal foil 116 wraps around both the leading end 112 and the trailing end 114 and is secured to a back of the panel 110. The shield 102 is configured in a manner similar to the shield 100.

In one embodiment, the divider 104 includes a first tab 130 and a flange 132 extending from the first tab 130, and a second tab 140 and a second flange 142 extending from the tab 140. The first flange 132 is coupled to the second flange 142 such that the divider 104 defines the gap distance G between the first shield 100 and the second shield 102. In one embodiment, the first flange 132 is slideably coupled to the second flange 142 such that the divider 104 is adjustable to enable adjustment of the gap G.

In one embodiment, the divider 104 is conductive and serves to further isolate the two sides 100, 102 of platform 44. For example, one embodiment provides the first tab 130 electrically coupled to the metal foil 116 of the first shield 100 by a conductor 134, and the second tab 140 electrically coupled to the metal foil 126 of the second shield 102 by a conductor 144. The conductors 134, 144 electrically couple to the shields 100, 102 to minimize the radiation of undesirable fields to the antennas 72, 82. The conductors 134, 144 include electrically conducting adhesive tape, although other forms of electrically coupling the metal foil 116, 126 to the divider 104 are also acceptable.

In alternative embodiments each of the first and second shields 100, 102 include a ferrite plate, or each of the first and second shields includes a carbon-filled foam plate. Other forms of shields 100, 102 configured to selectively impede the radiofrequency transmission between the antennas 72, 82 and labels that are not present in the gap G are also acceptable.

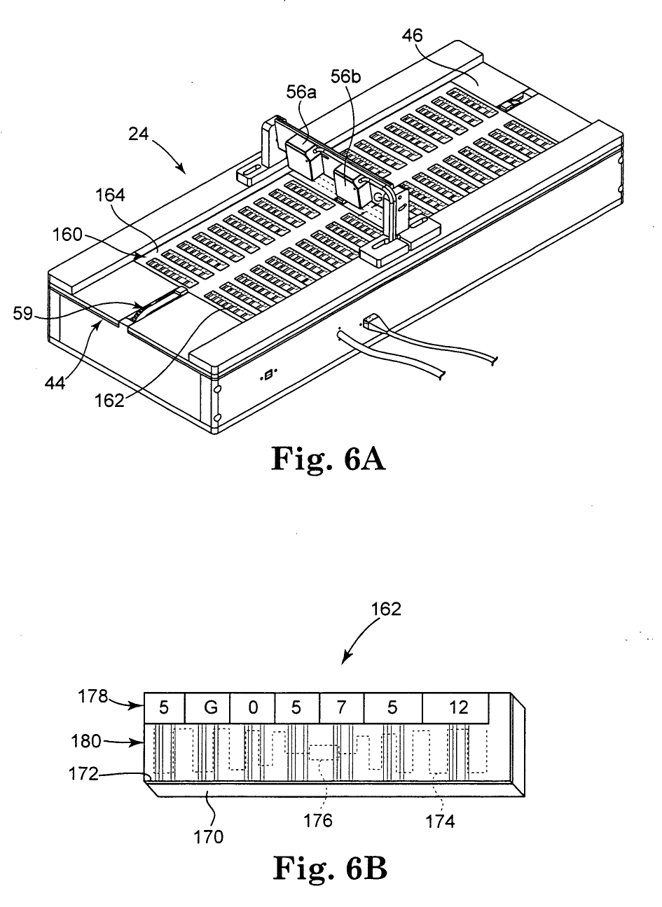

FIG. 6A is a perspective view of the label programmer 24 employed to initialize (or print) electronic information to an array 160 of RF-enabled labels 162. The array 160 of RF-enabled labels 162 includes multiple rows and multiple columns of labels 162 disposed on a carrier 164 that is indexed under scanners 56a, 56b. The carrier 164 is suitably indexed by the belt system 59 to pass one row of two columns of the labels 162 over the gap G for initialization. The scanners 56 optically read information from the rows of the labels 162, electronically communicate the information to the RF readers/writer 70 (FIG. 3), and the RF readers/writer 70 electronically programs chips in the labels 162 by transmitting the information through antennas 72, 82.

FIG. 6B is a perspective view of the RF-enabled label 162. In one embodiment, the RF-enabled label 162 includes an inlay 170 and a printed superstrate 172 disposed on the inlay 170. The inlay 170 maintains a label antenna 174 that is electrically coupled with a chip 176.

In one embodiment, the label antenna 174 is an ultra high frequency (UHF) antenna that is integrated within the chip 176 and the inlay 170. Other forms of the label antenna 174 are also acceptable. In general, the label antenna 174 is configured to electromagnetically interact with the RF reader/writer 70 (FIG. 3) in receiving/sending data. With this in mind, in one embodiment the label antenna 174 is a UHF-compatible EPC GEN 2 Class 1 RF antenna operable between 860-960 MHz and is configured to communicate information stored on the chip 176 to a transceiver module (not shown) in the mobile reader 24 (FIG. 1).

In one embodiment, the chip 176 is a memory chip capable of recording and/or storing device information, such as a format of data stored on a storage device and a VOLSER number associated with the device. In one embodiment, the memory of the chip 176 stores the data that is visually present on the printed superstrate 172 in addition to other information such as whether the label 162 is affixed to a container of devices, or whether the label 162 is affixed to a data storage device, or other tracking related information.

In one embodiment, the VOLSER number is a unique value that is specific to each data storage device it is associated with. In this specification, unique means an item exists as the only one such item. Thus, in one embodiment the VOLSER number specific to each data storage device identifies one and only one such data storage device, and there are no other data storage devices having that VOLSER number. This is in contrast to retail inventories having product labels, where any one label is employed to identify multiple items, such as any one of three dozen long sleeved shirts, or any one of seven cases of wine, and the sale or transaction of a shirt or one or more bottles of wine updates the number of shirts or bottles of wine still in inventory.

The chip 176 is preferably an electronic RFID chip including memory, where the memory has at least the capacity to be written with device information. In one embodiment, the chip 176 is an electronic memory chip capable of retaining stored data even in a power “off” condition, and is, for example, an RFID chip with memory available from, for example, NXP, Eindhoven, The Netherlands. In another embodiment, the chip 176 is an Alien RF-enabled chip available from Alien Technology, Morgan Hill, Calif. Those with skill in the art of memory chips will recognize that other memory formats and sizes for the chip 176 are also acceptable.

The superstrate 172 includes a first optical field 178 and a barcode field 180. In one embodiment, at least one of the information field 178 and the barcode field 180 includes multiple bits of data encoded to include alphanumeric identifiers encoded in ASCII and configured to identify a data storage device to which the label 162 is attachable, container information indicating the label 162 is attached to a data storage device or affixed to a container of data storage devices, and other information useful in tracking data storage devices.

The chip 176 is programmed to have a specific content and format for the information stored in memory. In one embodiment, the chip 176 electronically stores all of the data printed on the superstrate 172 including the fields described above and additional tracking data not visually evident on the superstrate 172. Many chips have a check value used to check data transmission accuracy. Some chips 176 have password protection. Chips 176 used in other applications have hardware encryption.

The VOLSER number can be user-defined or assigned by a manufacturer according to specifications provided by a customer. In general, the VOLSER number includes a character within the 80 bit field to mark the end of the VOLSER number, which enables the reading and interpretation of variable length and/or unique VOLSER numbers. In one embodiment, the bit pattern of the VOLSER number is not encrypted when reading or writing the VOLSER number to enable easy decoding by an outside source, such as a customer or client. In other embodiments, the VOLSER number is encrypted in software before sending to the label (for example, by inverting the bits, or by a more complex encryption such as a variation of Data Encryption Standard (DES) or Advanced Encryption Standard (AES)) to prevent decoding by an outside source, or encoded to save space in the memory of the chip 82.

In one embodiment, a check value is computed, transmitted, and stored with the data sent to the label. A check value is a small, fixed number of bits that can be employed to detect errors after transmission or storage of data. For example, in one embodiment the check value is computed and appended before transmission or storage, and verified afterwards by a recipient to confirm that no changes occurred on transmission of the data. Advantages of check values are that they are easily implemented, they can be analyzed mathematically, and are useful in detecting common errors caused by noise in transmission channels. (For example, a cyclic redundancy check (CRC) such as CRC 8 ATM, or CRC 16, or CRC 32 IEEE 802.3.)

In other embodiments, a parity check or other function may be employed to generate the check value for the data. A parity check usually refers to a check value that is the exclusive-or of the data being checked.

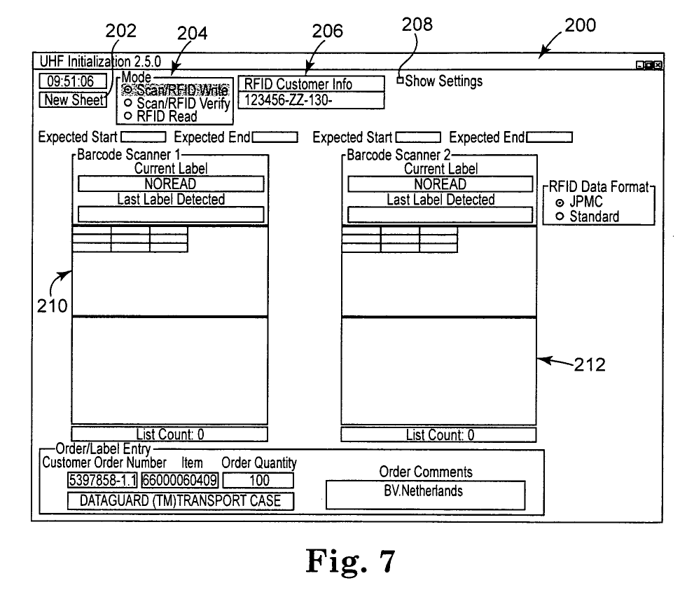

The label programming system 20 including the label programmer 24 that is employed to read the information from the fields 178, 180 of the superstrate 172 and communicate the optically read information to the RF read/write assembly 42 that writes the information to the chip 176 as described below in FIGS. 7-10.

FIGS. 7-10 are front views of screen images accessible through the GUI 30 (FIG. 1) used by an operator of the system 20. Each of FIGS. 7-10 makes additional reference to FIG. 1, which illustrate the controller 28 employing software viewable on the interface 22 and useful in initializing the RF-enabled labels 162 (as described above).

FIG. 7 is a front view of a start-up screen 200 including a new sheet button 202, a mode selector 204, a customer information field 206, a settings button 208, a field 210 for presenting information read by scanner 56a, and a field 212 for presenting information read from scanner 56b. In one embodiment, the new sheet button 202 is activated to erase any previous information stored when initializing a previous array of RF-enabled labels, which is recommended when beginning a new label initialization process. The mode selector 204 includes a scan/write option to enable the user to scan the labels 162 printed with the barcode 180 and convert that identifying information into RF codes while simultaneously writing the information to the chip 176. The customer information field 206 includes the customer's RFID identification number that is desirably written to the labels 162. The customer information field 206 includes 20-64 characters of writable information. The scanners 56 are provided with adjustment sliders configured to adjust the start and stop positions of the scanners 56. The settings button 208 provides a check box, that when checked, brings up settings to positionally align the barcode scanners 56a, 56b. In this manner, the user of the system 20 is enabled to adjust the scanners 56 to correspond with various sizes and shapes of the label array 160.

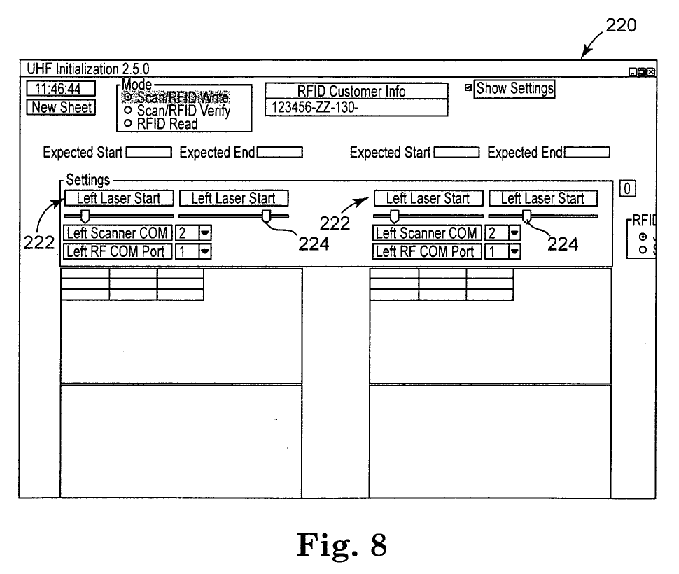

FIG. 8 is a front view of a screen 220. The left and right settings fields 222 include sliders 224 that may be moved with a mouse coupled to the interface 22 to adjust the scanners 56. In one embodiment, the settings 222 include a left scanner COM and a right scanner COM that provide COM ports. In one embodiment, a USB links the label programmer 24 to the interface 22 and the selection of the COM ports is automatic.

In one embodiment, the user types in the expected first number (a start number) and a last number (an expected end number) in each column of the labels 162 in the array 160. This is a useful option if the scanning process is expected to be interrupted, and/or if the operator is handling multiple arrays 160 of labels 162.

In one embodiment, the fields 210, 212 (FIG. 7) list the current barcode 180 for the label 162 that is being scanned near a top portion of the field and lists information for the last label 162 detected in each column of the array 160. In one embodiment, the column background areas turn green and a sensor beeps each time a label 162 is detected in its respective column. The label identification number appears (e.g., as text) in the respective column of the screen 220. Each column also includes a list count of the number of labels 162 detected. Labels 162 are counted only once even if they pass under the scanners 56 more than one.

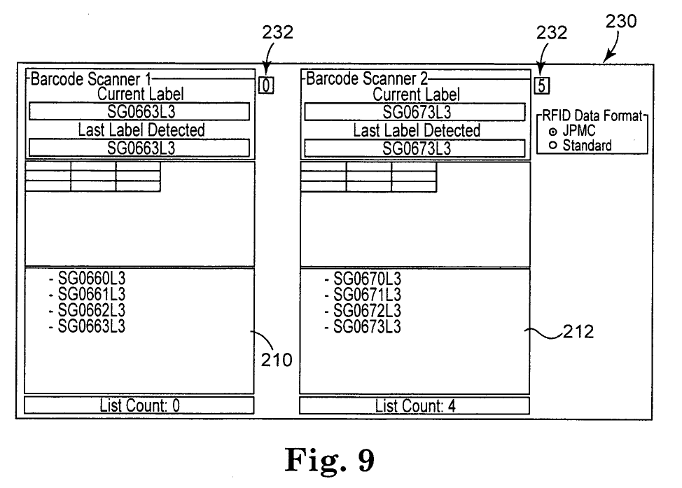

FIG. 9 is a front view of a screen 230 implemented by the software of the system 20. In one embodiment, a separate field 232 is provided adjacent to the scanner fields 210, 212 and provides a number that identifies the step of the label initialization process. For example, in one embodiment the field 230 includes the number zero to indicate that no label is being detected. The number 1 in the field 232 indicates that the programmer 24 is decoding the barcode 180 with the scanner 56. In this instance, the background turns green on each column that decodes the barcode. The number 2 in the field 232 indicates the programmer 24 is detecting the RFID tag portion of each label 162. The number 3 in the field 232 indicates that the programmer 24 is attempting to write information to the chip 176. The number 4 in the field 232 indicates that the programmer 24 is attempting to write a “kill password” to the chip 176. The “kill password” is provided to prevent an accidental or malicious overwriting of the chip 176 that will alter its identification number. A kill password is useful in that retail stores intentionally “kill” RFID tags as a security measure once the item bearing the tag has been purchased. The number 5 in the field 232 indicates that the initialization process employed by the programmer 24 is complete. In one embodiment, the initialization process occurs in a matter of seconds and is often so quick that the user generally is visually unable to observe the field 232 changing from the number 0 to 5.

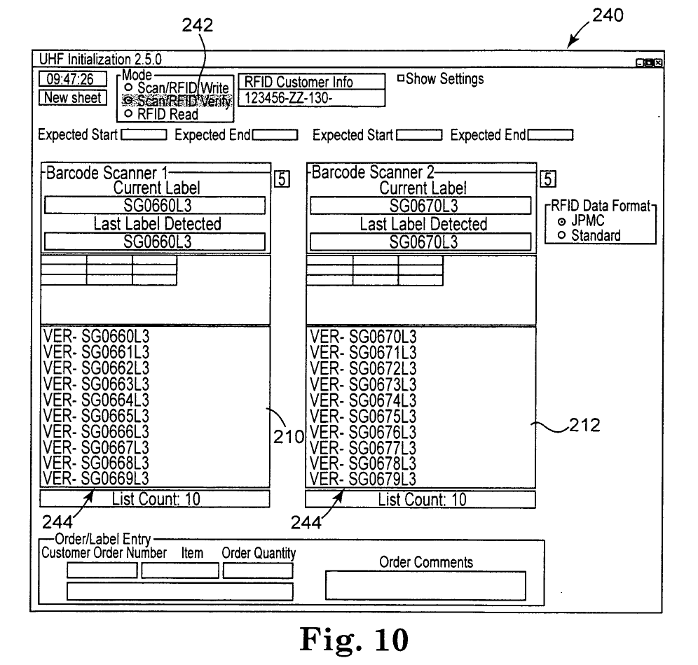

FIG. 10 is a front view of a screen 240 employed by the software of the system 20. The screen 240 provides a scan/RFID verify option 242 that enables the user to insure that both the printed barcode 180 information (on superstrate 172 in FIG. 6B) and the initialized RFID information written to the chip 176 matches. In one embodiment, after the chip 176 is written, the user clicks on the “scan/RFID verify” button 242 and then passes the array 160 of labels 162 below the scanners 56 a second time. The system 20 outputs a “VER” confirmation 244 in the fields 210, 212. The “VER” confirmation 244 is shown by the software whenever the written RFID number matches the printed barcode 180. In this manner, the user is enabled to ensure that the printed barcode in field 180 matches with the initialized RFID identification number stored on chip 176.

In one embodiment, the system 20 includes an auto verify feature that verifies initialization of initialized labels without having the operator initiate a second pass of the labels through the programmer. Other embodiments provide for one-pass label initialization and verification of label initialization. One exemplary flow chart includes:
A. The user:
   1. inserts a sheet of labels on the programmer between the tabs in the belt.
   2. indicates to the label programmer that it should program the tags.
B. The label programmer:
   1. advances and reads a first label.
   2. writes the first label's RFID chip.
   3. reads the first label's RFID chip.
   4. reports the first label's VOLSER number
   5. reads a second label.
   6. writes the second label's RFID chip.
   7. reads the second label's RFID chip.
   8. reports the second label's VOLSER number.
   9. repeats step B. 1 through B. 8 for labels 3 through 20.
   10. reads label 20's RFID chip.
   11. report the 20'th labels VOLSER number.
   12. reads label 19's RFID chip.
   13. advance backward to label 18
   14. repeats steps 10 through 13 for labels 18 through 1.
C. The user
   15. verifies that the labels were written properly.
   16. removes the sheet of labels from the programmer.

Embodiments provide a label programming system configured to scan a barcode of a label that is attachable to a data storage device and convert and UHF write the scanned information onto a chip of an RF-enabled inlay embedded within the label. Other embodiments provide a label programming system enabled to verify RFID-enabled tags by verifying that the information written to the chip matches the barcode printed on the label prior to attaching the label to the data storage device.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments of a label programmer, a label programming system, and method of initializing radiofrequency (RF)-enabled labels for attachment to a data storage device as discussed herein. Therefore, it is intended that this invention be limited only by the claims and the equivalents thereof.

What is claimed is:

1. A label programming system configured to initialize a radiofrequency (RF)-enabled label for attachment to a data storage device, the label programming system comprising:
a platform;
an RF read/write assembly disposed on a first side of the platform; and
an optical reader assembly in electrical communication with the RF read/write assembly, the optical reader assembly disposed on a second side of the platform opposite the first side;
wherein the optical reader assembly is configured to optically read information from the RF-enabled label and communicate the information to the RF read/write assembly that is configured to write the information to a chip of the RF-enabled label.

2. The label programming system of claim 1, wherein the RF read/write assembly comprises an ultra high frequency RF read/write assembly and the optical reader assembly comprises multiple optical reader assemblies each disposed on the second side of the platform, and each optical reader assembly is configured to optically read information from one RF-enabled label of multiple of RF-enabled labels traversing the gap and electrically communicate the information to the ultra high frequency RF read/write assembly that is configured to write the information to a chip of the one RF-enabled label.

3. The label programming system of claim 2, wherein the ultra high frequency RF read/write assembly comprises an ultra high frequency RF reader/writer unit electrically coupled to a pair of ultra high frequency RF antennas.

4. The label programming system of claim 3, wherein each of the ultra high frequency RF antennas is disposed in a line-of-sight gap formed in the platform.

5. The label programming system of claim 3, wherein the ultra high frequency RF reader/writer unit is electrically coupled to each of the ultra high frequency RF antennas with a co-axial cable having a ferrite core configured to electrically isolate the ultra high frequency RF antennas from electromagnetic interference.

6. The label programming system of claim 2, wherein each RF-enabled label comprises an ultra high frequency RFID inlay coupled to an optical label comprising a barcode.

7. The label programming system of claim 6, wherein the information is printable to the barcodes and electronically writeable to the chips of the inlay, the information comprising:
an identifier that is configured to identify an item to which the RF-enabled label is attachable; and
container information identifying the RF-enabled label is affixed to one of a data storage device and a container of data storage devices.

8. The label programming system of claim 7, wherein the alphanumeric identifier comprises an encoded VOLSER number of the data storage device.

9. A label programming system configured to initialize a label for attachment to a data storage device, the system comprising:
a platform comprising a first shield and a second shield spaced from the first shield by a gap;
a radiofrequency (RF) read/write assembly disposed on a first side of the platform; and
an optical reader assembly in electrical communication with the RF read/write assembly, the optical reader assembly disposed on a second side of the platform opposite the first side;
wherein the optical reader assembly is configured to optically read information from an RF-enabled label presented in the gap and communicate the information to the RF read/write assembly that is configured to write the information to a chip of the RF-enabled label.

10. The label programming system of claim 9, further comprising:
a divider electrically coupled between the first shield and the second shield, the divider configured to define the gap between the first and second shields;
wherein the divider comprises a first portion electrically coupled to the first shield and a second portion electrically coupled to the second shield, the first and second portions slideably coupled together to define an adjustable divider configured to adjust the gap between the first and second shields.

11. The label programming system of claim 9, wherein the first and second shields each comprise a panel having a leading end opposite a trailing end and a metal foil wrapped around a portion of the panel.

12. The label programming system of claim 11, wherein each panel comprises a plastic panel and the metal foil is wrapped around the trailing ends of the plastic panel, the leading ends spaced apart to define the gap between the first and second shields.

13. The label programming system of claim 11, wherein the metal foil is wrapped around the leading ends and the trailing ends of the plastic panels.

14. The label programming system of claim 9, wherein the first and second shields each comprise a ferrite plate.

15. The label programming system of claim 9, wherein the first and second shields each comprise a carbon filled foam plate.

16. A method of initializing a label for attachment to a data storage device, the method comprising:
providing an array of radiofrequency (RF)-enabled labels;
optically reading information from one of a row and a column of the array of RF-enabled labels;
shielding all but the row/column of the RF-enabled labels that was optically read; and
radiofrequency writing the optically read information to a chip in each RF-enabled label in the row/column of the RF-enabled labels that was not shielded.

17. The method of claim 16, wherein each RF-enabled label comprises a superstrate coupled to an inlay, the superstrate including a barcode comprising a unique identifier that is configured to identify the data storage device to which the RF-enabled label is attachable.

18. The method of claim 16, wherein shielding all but the row/column of the RF-enabled labels that was optically read comprises:
supporting the array of RF-enabled labels with a platform comprising a first shield spaced from a second shield by a gap, the first and second shields comprising a metal surface;
disposing the array of RF-enabled labels on the metal surface of the first and second shields; and
disposing the row/column of non-shielded RF-enabled labels within the gap.

19. The method of claim 18, wherein the metal surface of the first and second shields comprises a metal foil disposed over a major surface of each of the first and second shields and a metal foil disposed over an opposed trailing end of each of the first and second shields.

20. The method of claim 16, wherein radiofrequency writing comprises ultra high frequency writing the optically read information to a chip in each RF-enabled label in the row/column of the RF-enabled labels that was not shielded.
